(19) United States
(12) Patent Application Publication
(10) Pub. No.: US 2013/0308467 A1
(43) Pub. Date: Nov. 21, 2013

(54) SYSTEM FOR VIRTUAL NETWORK ROUTING

(71) Applicant: Erik Knight, Phoenix, AZ (US)

(72) Inventor: Erik Knight, Phoenix, AZ (US)

(73) Assignee: KNIGHTEK LLC, Phoenix, AZ (US)

(21) Appl. No.: 13/472,993

(22) Filed: May 16, 2012

(51) Int. Cl. H04L 12/56; H04L 12/26

(52) U.S. Cl. 370/248

(57) ABSTRACT

A system for virtual data network routing is provided, wherein network routers are deployed to multiple sites. Upon connecting the network routers to a public network, the network routers communicate their network location to a monitoring facility. The monitoring facility tests packet loss, latency, and packet hop count between various network routers on the virtual data network. The monitoring facility provides network routing tables to the network routers, allowing the network routers to transmit packets in an efficient manner, avoiding high packet loss, decreased transmission time, and maintaining quality of service requirements.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates to data packet routing methods for data networks, namely data networks wherein remote devices located on a wide area network are to be treated as though they are located on a local network.

2. Description of the Related Art

In a multisite data network deployment, data packets are transmitted from an initial endpoint to a final endpoint. During transmission, the packet may travel through several nodes, making several “hops” through intermediate devices or nodes prior to being received at the final endpoint. Each hop can increase network latency, create an increased chance of packet loss, and cause an overall loss in signal quality.

In an effort to reduce the number of hops (the hop count) a data packet makes during transit, some networks attempt to utilize static routing tables, which provide routing instructions to a network router at the initial endpoint, determining the network path for transmission of the packet. These static routing tables are frequently determined solely by hop count, with little regard to network latency and packet loss. Due to this constraint, static routing tables fail to take into account changes in network traffic and node reliability, thus creating suboptimal routes for packet transmission.

Some networks utilize multiprotocol label switching (MPLS) as an alternative to static routing tables. In an MPLS system, routes are provided with labels, allowing packets to be assigned routes based on the class of service associated with the packet. In order to effectively provide labels for routes from one endpoint to another, MPLS is restricted to private networks where the possible paths from one endpoint to another are known. This creates difficulty for multisite data network deployment, since new sites would require extensive configuration to connect to the MPLS network.

A solution is needed to address one or more of these shortcomings in the prior art.

### BRIEF SUMMARY OF THE INVENTION

The present invention provides a system in which data packet routing may be provided in a manner similar to MPLS over a public network, effectively creating a private network within the public network.

In the system for virtual network routing, network routers are deployed to multiple sites. After the routers are connected to the public network, the routers communicate with a monitoring facility, communicating their network location to the monitoring facility. The monitoring facility then stores the router's network location for use in establishing dynamic routing tables within a virtual network. The monitoring facility tests to connections between various endpoints on the virtual network, collecting information regarding packet loss, latency, and hop count.

After collecting packet loss, latency, and hop count information, the monitoring facility determines possible paths for data packet, or network, traffic. These paths are prioritized, such that higher priority routs have a reduced latency and risk of packet loss, while maintaining quality of service (QOS) requirements for a particular class of service (COS).

These paths are organized into dynamic routing tables, which are passed to the routers connected to the virtual network. The routers then utilize the dynamic routing tables to direct network traffic.

The monitoring facility frequently retests connections between the various endpoints on the virtual network. After each successive test of the data connections, the monitoring facility reconstructs the dynamic routing tables. The monitoring facility then passes the updated dynamic routing tables to the network routers, allowing the network routers to maintain a stable data connection with other endpoints on the network.

### BRIEF DESCRIPTION OF THE SEVERAL VIEWS OF THE DRAWING

FIG. 1 depicts a schematic for the system for virtual network routing.

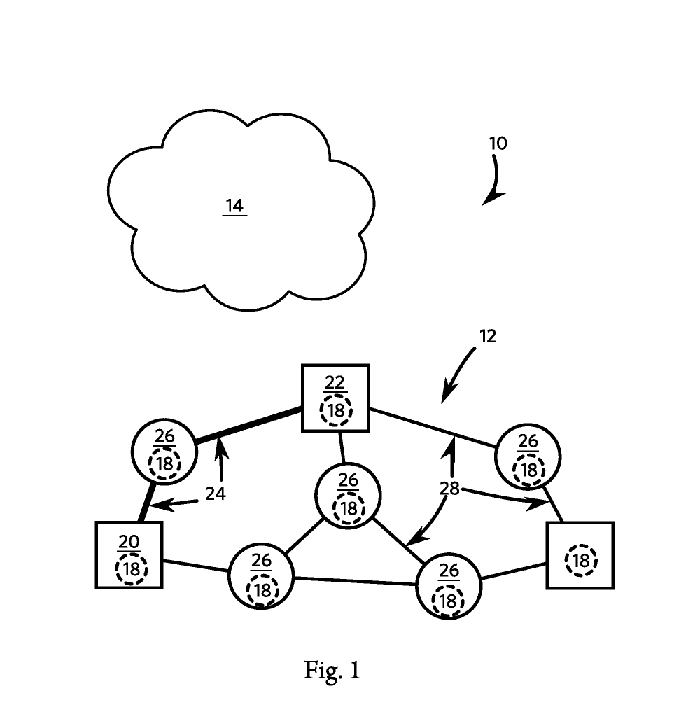

### DETAILED DESCRIPTION OF THE INVENTION

The system for virtual network routing 10 comprises a data network 12 and a monitoring facility 14. The data network 12, comprises a first endpoint 20, a final endpoint 22, multiple nodes or routers 26, and data connections 28 connecting the first endpoint 20, the final endpoint 22, and nodes 26. The first endpoint 20, final endpoint 22, and nodes 26 are each equipped with a router 18. Each of the first endpoint 20, final endpoint 22, and nodes 26 may be located at the same site, or multiple sites. The data connections 28 may be T1, 3G, 4G, cable, fiber, DSL, or other high speed broadband connection. The data connections 28 may be public, private, or a combination of both.

After a router 18 is connected to the data network 12 by means of a data connection 28 and receives a network address, the router 18 transmits its network address and other identifying information, such as a hardware identification (HWID) and network identification (NID), to a monitoring facility 14. The monitoring facility 14 then stores the network address of the router 18 in a database for use in establishing dynamic routing tables within the data network 12.

The monitoring facility 14 tests the data connections 28 between various endpoints 20, 22, 26 on the data network 12, collecting information regarding packet loss, latency, and hop count. This may be accomplished by sending test data packets through various data connections 28 and nodes 26. Upon receiving the test data packets, the monitoring facility 14 can calculate data network 12 information, such as latency and data packet loss, attributable to specific data connections 28.

After collecting the data network 12 information, the monitoring facility 14 is able to determine a preferred path 24 between the first endpoint 20 and final endpoint 22, as well as prioritize less preferred paths through the data connections 28. A preferred path 24 may be preferred due to a low hop count, low latency, low packet loss, effect on quality of service, or other considerations for a given class of service (COS). This process is repeated for each of the endpoints 20, 22, 26 in the data network 12.

The monitoring facility 14 compiles these preferred paths 24 and data connections 28 in a dynamic routing table. The dynamic routing table is distributed to the routers 18 by means of push data, or the routers 18 requesting the information directly from the monitoring facility 14.

The monitoring facility 14 continues to test the data connections 28. As changes are found, the dynamic routing tables are updated to reflect changes in the environment or data network 12. As these dynamic routing tables are updated, the information is passed to the routers 18.

The automatic updating of the dynamic routing tables allows the routers 18 to update the preferred path 24 and assign a preferred path 24 to transmitted data packets within the data network 12.

The continual testing of the data connections 28 and updating of the dynamic routing tables allow an endpoint 20, 22, 26 to be removed or inserted with minimal effect to the remaining endpoints 20, 22, 26.

Optionally, identifying information sent from the router 18 to the monitoring facility 14 may include hardware temperature, memory usage, router 18 uptime, and bandwidth usage. System administrators may be able to access the identifying information through a webserver hosted in the monitoring facility 14 or within an endpoint 20, 22, or node 26.

I claim:

1. A system for virtual network routing, comprising:
(A) a data network, the data network comprising
(i) two or more routers capable of receiving and transmitting network data packets, and
(ii) data connections connecting the two or more routers; and
(B) a monitoring facility comprising one or more computers; wherein
(C) the two or more routers transmit identifying information to the monitoring facility;
(D) the monitoring facility receives the identifying information and performs connectivity tests on the data connections between the two or more routers;
(E) the monitoring facility determines at least one preferred path for a data packet to be transmitted through the data network;
(F) the monitoring facility automatically compiles one or more routing tables based on the preferred path;
(G) the routing tables are transmitted to the routers;
(H) the routers utilize the routing tables in the process of transmitting data packets; and
(I) the monitoring facility automatically repeats the connectivity tests, redetermines at least one preferred path, compiles one or more routing tables, and transmits the routing tables to the routers.

2. The system of claim 1, wherein the identifying information includes at least one of:
(A) a hardware identifier;
(B) a network address;
(C) a network identifier;
(D) hardware temperature;
(E) memory usage;
(F) router uptime; and
(G) bandwidth usage.

3. The system of claim 2, wherein the connectivity tests include at least one of: determining a rate of data packet loss, determining network latency, and determining a hop count.

4. The system of claim 3, wherein the preferred path accomplishes at least one of:
(A) reducing data packet loss;
(B) reducing network latency; and
(C) lowers the path hop count.

5. The system of claim 4, wherein the monitoring facility further comprises a network server accessible through the data network, such network server being programmed to display at least one of: memory usage and bandwidth usage.
